(19) United States
(12) Patent Application Publication
(10) Pub. No.: US 2023/0079263 A1
(43) Pub. Date: Mar. 16, 2023

(54) DIAGNOSTIC APPARATUS FOR A SAND METERING DEVICE FOR A SANDING SYSTEM FOR A RAIL VEHICLE, AND METHOD FOR CARRYING OUT A DIAGNOSIS FOR A SAND METERING DEVICE FOR A SANDING SYSTEM FOR A RAIL VEHICLE

(71) Applicant: KNORR-BREMSE GESELLSCHAFT MIT BESCHRÄNKTER HAFTUNG, Mödling (AT)

(72) Inventors: Georg KRISMANIC, Wein (AT); Albert MISSLIWETZ, Wein (AT); Gerhardus DE VRIES, Mödling (AT)

(21) Appl. No.: 17/800,865

(22) PCT Filed: Feb. 16, 2021
(86) PCT No.: PCT/EP2021/053734

§ 371 Date: Aug. 18, 2022

(30) Foreign Application Priority Data
Feb. 18, 2020 (DE) 10 2020 104 216.7

(51) Int. Cl. B61C 15/10; G07C 5/08

(52) U.S. Cl. CPC B61C 15/102; G07C 5/0808

(57) ABSTRACT

A diagnostic apparatus for a sand metering device for a sanding system for a rail vehicle includes a detection device and an evaluation device. The detection device is designed to detect at least one parameter of the sand metering device of the sanding system and to provide a detection signal representing the parameter. The evaluation device is designed to output a metering error signal using the detection signal, which metering error signal indicates a malfunction of the sand metering device if the parameter deviates from a target parameter.

The present approach relates to a diagnostic apparatus for a sand metering unit for a sanding system for a rail vehicle and a method for carrying out a diagnosis for a sand metering unit for a sanding system for a rail vehicle.

Sanding systems are used in rail vehicles to apply sand or other bulk material onto the rail in front of the wheel which rolls over the sand or directly into the wheel rail gap in order to increase the coefficient of friction between the wheel and the rail or to return it to a value that was originally higher. The traction and braking of a rail vehicle can be improved using this measure. It is often considered that sanding systems contribute significantly to reducing the risk of accidents which entail significant property damage, personal injury or death, since braking with sand applied can shorten the braking distance. The sand metering unit, which comprises a sand metering device and a sand delivery device, is an essential part of the sanding system.

Against this background, the object of the present approach is to provide an improved diagnostic apparatus for a sand metering unit for a sanding system for a rail vehicle and an improved method for carrying out a diagnosis for a sand metering unit for a sanding system for a rail vehicle.

This object is achieved by means of a diagnostic apparatus which has the features of device claim 1, by means of a method claim 11 and by means of a computer program claim 12.

The advantages that can be afforded by the approach presented here are that of providing a diagnostic apparatus which quickly and easily detects a malfunction of a sand metering unit of a sanding system. A sanding process for a rail vehicle can thus be monitored and a defect can be corrected if necessary. This affords the possibility of significantly increasing safety when the rail vehicle brakes.

A diagnostic apparatus for a sand metering unit for a sanding system for a rail vehicle comprises a detection device and an evaluation device. The detection device is designed to detect at least one parameter of the sand metering unit of the sanding system and to provide a detection signal representing the parameter. The evaluation device is designed to output a metering error signal using the detection signal, which metering error signal indicates a malfunction of the sand metering unit if the parameter deviates from a target parameter.

The sand metering unit is to be understood as a unit consisting of at least one sand metering device and, additionally or alternatively, a sand delivery device. The sand metering device is designed to dose a quantity of sand or any other bulk material to be discharged during sanding. The sand delivery device is designed to deliver the sand or bulk material onto the rail or into the wheel rail gap, for example using compressed air. The parameter can be any operating parameter during operation of the sand metering unit, for example a sensor value of the sand metering device sensed during operation of the sand metering device or a sensor value of the sand delivery device sensed during operation of the sand delivery device. The target parameter can be a stored comparison value or one input by the diagnostic apparatus, which can be compared with the parameter in the evaluation device. The detection device can have at least one sensor for sensing the parameter and additionally or alternatively a provision device for providing the detection signal. The detection device can be arranged, for example, in or on the sand metering unit and the evaluation device can be arranged or implemented in a sanding controller of the sand metering unit. Such a diagnostic apparatus advantageously makes it possible to monitor the operation of the sand metering unit and to detect a malfunction.

The detection device can be designed to detect a position of a piston of a sand metering device of the sanding system as the parameter and to provide a position signal representing the position as the detection signal, wherein the evaluation device is designed to output a sand metering error signal using the position signal as the metering error signal which indicates a malfunction of the sand metering device if the position deviates from a target position. The target position can represent a target position of the piston that is required according to a requested sanding process. In this way, the actual position of the piston can be used to determine whether the sanding process is being carried out correctly.

Further advantageously, the diagnostic apparatus has an activation device designed to output an activation signal which is designed to bring about a piston movement of the piston to the target position. In this way, it can be actively checked that the sanding process is correct.

For example, the activation device can be designed to output the activation signal which is designed to bring about the piston movement of the piston to the target position, which is an opened open position of the piston. The open position is to be understood as an open state of the piston in which sand can be dispensed. This makes it possible to check whether a requested dispensing of sand can actually take place.

According to one embodiment, the activation device can be designed to automatically output the activation signal in response to a manually effected, input actuation, and additionally/or alternatively in a defined time interval, in particular in a pulse-width modulation interval. For example, a driver of the rail vehicle can check at any time, for example by pressing a corresponding button, whether the piston can be moved properly into the open position. An automatic check in a defined time interval allows a regular and therefore particularly secure checking method.

For example, the detection device can be designed to detect an open position of the piston as the position and to provide an open signal representing the open position, and additionally/or alternatively, to detect a closed position of the piston and to provide a closed signal representing the closed position, and additionally/or alternatively, to detect at least one center position of the piston between the open position and the closed position and to provide a center signal representing the center position. The metering error signal can be output, for example, if, in response to an output of the activation signal, the closed signal and additionally or alternatively the center signal are input within a defined time period and additionally or alternatively no open signal is input. If, however, the open signal is input in response to the activation signal, no metering error signal can be output since the piston executes the correct requested movement in such a case.

Further advantageously, the detection device according to one embodiment can be designed to detect a delivery pressure of a sand delivery device of the sanding system as the parameter and to provide a delivery pressure signal representing the delivery pressure as the detection signal, wherein the evaluation device is designed to output a pressure error signal using the delivery pressure signal as the metering error signal which indicates a malfunction of the sand delivery device if the delivery pressure deviates from a target delivery pressure. Correct delivery pressure is also essential for carrying out a sanding process. In such an embodiment, current delivery pressure can be used to check the sand delivery device. The target delivery pressure can be a stored value.

The detection device can comprise at least one reed sensor, proximity sensor, microswitch, triangulation rangefinder, permanent magnet and additionally or alternatively at least one delivery pressure sensor. Such sensors are suitable for detecting one of the parameters described above, for example for detecting the position of the piston and additionally or alternatively for detecting the delivery pressure of the sand delivery device.

The evaluation device can also be designed to use the detection signal to output a metering function signal which indicates correct functioning of the sand metering unit when the parameter corresponds to the target parameter. The evaluation device can be designed to use the position signal to output a sand metering function signal which indicates correct functioning of the sand metering device when the position corresponds to the target position, and additionally or alternatively to use the delivery pressure signal to output a pressure function signal which indicates correct functioning of the sand delivery device when the delivery pressure corresponds to the stored target delivery pressure. This affords an opportunity to make a positive check result detectable too.

According to one advantageous embodiment, the evaluation device can be designed to output the metering error signal, which is designed to indicate the malfunction of the sand metering unit so as to be visually, haptically, and additionally or alternatively, acoustically perceptible to a driver of the rail vehicle. In this case, the malfunction can be displayed so as to be, for example, optically, haptically, and additionally or alternatively, acoustically perceptible to the driver of the vehicle. The malfunction can thus be recognized by the driver of the vehicle and repairs to the device in question can be initiated as quickly as possible.

A method for carrying out a diagnosis for a sand metering unit for a sanding system for a rail vehicle comprises a detection step and an output step. In the detection step, a parameter of the sand metering unit is detected and a detection signal representing the parameter is provided. In the output step, a metering error signal is output using the detection signal if the parameter deviates from a target parameter, wherein the metering error signal indicates a malfunction of the sand metering unit.

This method can be implemented, for example, in software or hardware or in a combined software and hardware form, for example in a control unit.

A computer program product or computer program with program code, which can be stored on a machine-readable storage medium such as a semiconductor memory, a hard disk memory or an optical memory, for carrying out, implementing and/or controlling the steps of the method according to one of the embodiments described above is also advantageously used, in particular when the program product or program is run on a computer or device.

Exemplary embodiments of the approach presented here will be discussed in more detail in the following description with reference to the figures, in which:

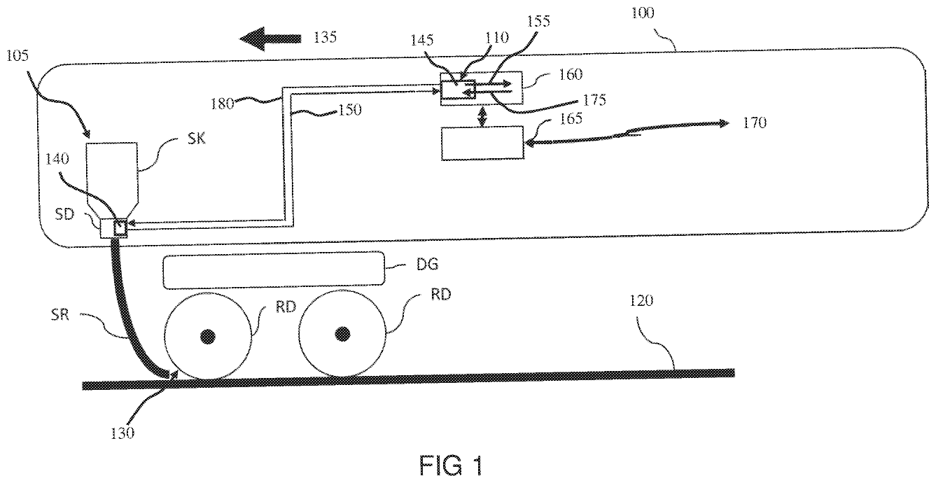

FIG. 1 is a schematic illustration of a rail vehicle with a sanding system with a sand metering unit and a diagnostic apparatus according to one exemplary embodiment;

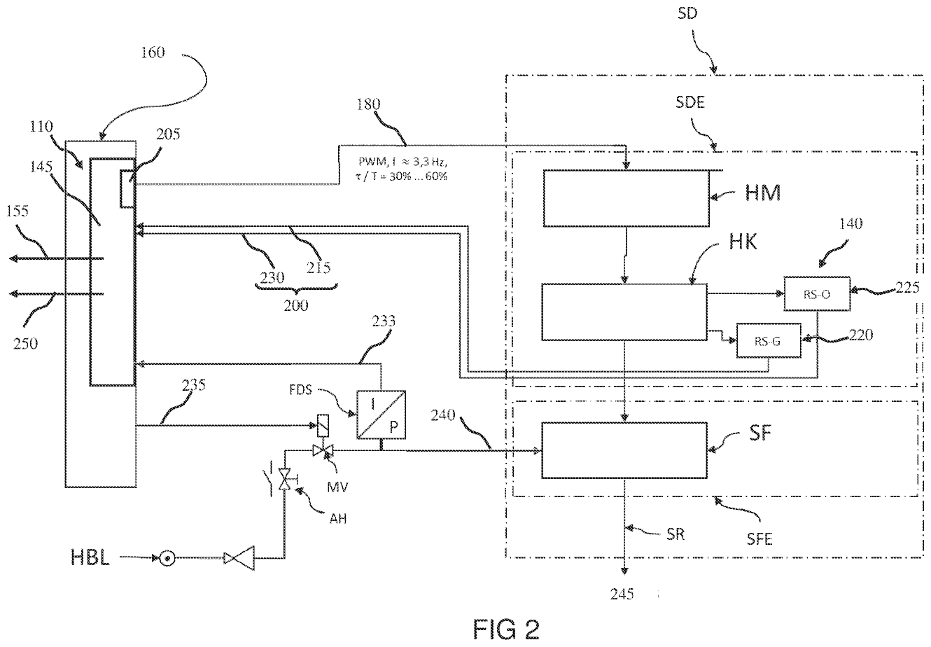

FIG. 2 is a schematic illustration of a diagnostic apparatus according to one exemplary embodiment; and

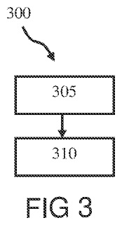

FIG. 3 is a flowchart of a method for carrying out a diagnosis for a sand metering unit for a sanding system for a rail vehicle according to one exemplary embodiment.

In the following description of expedient exemplary embodiments of the present approach, identical or similar reference designations are used for the elements of similar action that are illustrated in the various figures, wherein a repeated description of these elements will not be given.

FIG. 1 is a schematic illustration of a rail vehicle 100 with a sanding system 105 with a sand metering unit SD and a diagnostic apparatus 110 according to one exemplary embodiment.

The sanding system 105 is designed to carry out a sanding process for the rail vehicle 100. During the sanding process, sand or other bulk material is applied onto a rail 120 in front of the wheel RD which rolls over the sand or directly into a wheel rail gap 130 in order to increase the coefficient of friction between the wheel RD and the rail 120 or to return it to a value that was originally higher, with the result that the rail vehicle 100 is braked. According to this exemplary embodiment, the wheel RD is one of four wheels RD which are connected to the vehicle 100 by means of a bogie DG. An arrow shows the direction of travel 135 of the rail vehicle 100.

According to this exemplary embodiment, the sanding system 105 has a sand box SK for storing sand, the sand metering unit SD and/or a sand pipe SR for guiding the sand in front of the wheel RD or into the wheel rail gap 130. According to this exemplary embodiment, the sand metering unit SD is arranged between the sand box SK and the sand pipe SR and has at least one sand metering device and/or a sand delivery device. The sand metering device is designed to dose a quantity of sand or any other bulk material to be discharged during the sanding process. The sand delivery device is designed to deliver the sand or bulk material onto the rail 120 or into the wheel rail gap 130.

The diagnostic apparatus 110 has a detection device 140 and an evaluation device 145. The detection device 140 is designed to detect at least one parameter of the sand metering unit SD of the sanding system 105 and to provide a detection signal 150 representing the parameter. The evaluation device 145 is designed to output a metering error signal 155 using the detection signal 150, which metering error signal indicates a malfunction of the sand metering unit SD if the parameter deviates from a target parameter.

Purely by way of example, the detection device 140 according to this exemplary embodiment is implemented on or in the sand metering unit SD and/or the evaluation device 145 in a sanding controller 160 of the sanding system 105. According to this exemplary embodiment, the sanding controller 160 is connected for signaling to a vehicle controller 165 of the rail vehicle 100. According to this exemplary embodiment, the vehicle controller 165 in turn has a communication interface with a vehicle driver 170 of the rail vehicle 100.

According to this exemplary embodiment, the parameter of the sand metering unit SD is any operating parameter during operation of the sand metering unit SD, for example a sensor value of the sand metering device sensed during operation of the sand metering device and/or a sensor value of the sand delivery device sensed during operation of the sand delivery device. According to one exemplary embodiment, the target parameter is a comparison value stored internally in the sanding controller 160 and input in the form of a target parameter signal 175 or a comparison value external to the sanding controller 160 input by the diagnostic apparatus 110 in the form of the target parameter signal 175. According to one exemplary embodiment, the evaluation device 145 is designed to compare the parameter with the target parameter. According to one exemplary embodiment, the detection device 140 has at least one sensor for detecting the parameter. According to this exemplary embodiment, the evaluation device 145 is further designed to output an activation signal 180 to cause the sand metering unit SD to function to obtain the parameter.

By virtue of the diagnostic apparatus 110 presented here, it is possible to detect a failure of the sand metering device and/or sand delivery device while driving and/or to check the function of the sand metering and sand delivery device at regular intervals without interrupting driving. It is thus advantageously possible to use the sanding system 105 for risk-reducing measures, and specifically for measures that reduce braking distances.

The approach presented here relates to a diagnostic apparatus 110 for a mechanical sand metering device and a pneumatic sand delivery device for the sanding system 105 for the rail vehicle 100, with the sand metering device being implemented according to one exemplary embodiment by at least one electrically or pneumatically operated metering piston, which is opened and closed in periodic patterns during metering.

FIG. 2 is a schematic illustration of a diagnostic apparatus 110 according to one exemplary embodiment. This can be an exemplary embodiment of the diagnostic apparatus 110 as described with reference to FIG. 1.

According to this exemplary embodiment, the detection device 145 is designed to detect a position of the metering piston, also referred to as “piston” HK hereinafter, of the sand metering device SDE of the sanding system 105 as the parameter and to provide a position signal 200 representing the position as the detection signal, wherein the evaluation device 145 is designed to output a sand metering error signal using the position signal 200 as the metering error signal 155 which indicates a malfunction of the sand metering device SDE if the position deviates from a target position. According to one exemplary embodiment, the target position represents a target position of the piston HK that is required according to a requested sanding process.

According to this exemplary embodiment, the diagnostic apparatus 110 has an activation device 205 designed to output the activation signal 180 which is designed to bring about a piston movement of the piston HK to the target position. According to this exemplary embodiment, the activation device 205 is in this case designed to output the activation signal 180 which is designed to bring about the piston movement of the piston HK to the target position, which is an opened open position of the piston HK. The open position is to be understood as an open state of the piston HK in which sand can be dispensed. According to one exemplary embodiment, the activation signal 180 activates a solenoid HM of the sand metering device SDE in such a way that the piston HK is opened and closed in periodic patterns. According to this exemplary embodiment, the activation device 205 is designed to automatically output the activation signal 180 in response to a manually effected, input actuation and/or in a defined time interval, in particular in a pulse-width modulation interval. According to one exemplary embodiment, the activation signal 180 is output during a sanding process as a pulse-width modulation signal, or PWM signal for short, with a frequency of 3.3 Hz and/or a duty cycle of between 30 percent and 60 percent.

According to this exemplary embodiment, the detection device 140 is designed to detect the open position of the piston HK as the position and to provide an open signal 230 representing the open position and/or to detect a closed position of the piston HK and to provide a closed signal 215 representing the closed position and/or to detect at least one center position of the piston HK between the open position and the closed position and to provide a center signal representing the center position. According to one exemplary embodiment, the evaluation device 145 is designed to output the metering error signal if, in response to an output of the activation signal 180, the closed signal and/or the center signal are input and/or no open signal 230 is input within a defined time period.

In order to detect the position, the detection device 140 according to this exemplary embodiment has at least one reed sensor 220, proximity sensor, microswitch, triangulation rangefinder and/or permanent magnet. According to this exemplary embodiment, the reed sensor 220 has a pair of reed contacts which, according to this exemplary embodiment, is arranged in a closed position RS-G when the piston HK is in the closed position, in which the reed sensor 220 according to this exemplary embodiment provides the closed signal 215. According to one exemplary embodiment, the pair of reed contacts is arranged in a closed position when the piston HK is in the closed position, in which the reed sensor 220 provides the closed signal, and/or in the open position when the piston HK is in the center position, in which the reed sensor 220 also provides the open signal.

According to this exemplary embodiment, the detection device 140 has at least one additional reed sensor 225, which has an additional pair of reed contacts, which, according to this exemplary embodiment, is arranged in an open position RS-O when the piston is in the open position. The additional reed sensor 225 is designed to provide, as a further position signal 200, a first feedback signal 230 representing an open position RS-O of the additional pair of reed contacts to the evaluation device 145 and/or a second feedback signal representing a closed position of the additional pair of reed contacts to the evaluation device 145.

According to this exemplary embodiment, the detection device 140 is designed to detect a delivery pressure of the sand delivery device SFE of a sand delivery unit SF of the sand metering unit SD of the sanding system as the parameter and to provide a delivery pressure signal 233 representing the delivery pressure as the detection signal, wherein the evaluation device 145 is designed to output a pressure error signal using the delivery pressure signal 233 as the metering error signal 155 which indicates a malfunction of the sand delivery device SFE if the delivery pressure deviates from a target delivery pressure. According to this exemplary embodiment, the target delivery pressure is a stored value.

In order to detect the delivery pressure, the detection device 140 according to this exemplary embodiment has at least one delivery pressure sensor FDS. In response to an additional activation signal 235 output by the sanding controller 160 or the evaluation device 145, according to this exemplary embodiment, a solenoid valve MV is opened which is connected via a shut-off valve AH to a compressed air tank of a main air tank line HBL of the rail vehicle. The delivery pressure sensor FDS is arranged and designed to sense the delivery pressure of delivery air 240 which is directed into the sand delivery unit SF during the sanding process in order to cause a sand flow 245 of the metered sand through the sand pipe SR.

According to this exemplary embodiment, the evaluation device 145 is further designed to output a metering function signal 250 using the detection signal, which metering function signal indicates correct functioning of the sand metering unit SD if the parameter corresponds to the target parameter. According to this exemplary embodiment, the evaluation device 145 is designed to use the position signal 200 to output a sand metering function signal which indicates correct functioning of the sand metering device SDE when the position corresponds to the target position, and/or to use the delivery pressure signal 233 to output a pressure function signal which indicates correct functioning of the sand delivery device SFE when the delivery pressure corresponds to the stored target delivery pressure.

According to this exemplary embodiment, the evaluation device 145 is designed to output the metering error signal 155, which is designed to indicate the malfunction of the sand metering unit SD to the driver of the rail vehicle so as to be visually, haptically and/or acoustically perceptible, and/or to indicate the metering function signal 250 to the vehicle driver so as to be visually, haptically and/or acoustically perceptible.

An idea underlying the invention is to detect the position of the piston HK using the sensors 220, 225. The position of the piston HK to be detected is at least the open position. According to one exemplary embodiment, further positions to be advantageously detected in the sequence are the closed position, the center position and/or a continuously detected position of the piston HK. According to one exemplary embodiment, suitable sensors 220, 225 for position detection include reed contacts, inductive proximity sensors, microswitches and triangulation rangefinders. The evaluation device 145 can infer functioning or a failure of the piston HK from temporal position detection. Furthermore, the evaluation device 145 can infer the amount of sand that has been discharged. According to one exemplary embodiment, the evaluation device 145 is designed to detect faulty activation of the sanding process if it is detected that the piston HK is executing a movement despite the absence of an activation signal 180.

According to one exemplary embodiment, a regular check of the functioning of the metering device SDE is implemented by activating the piston HK very briefly and thus without any, or hardly any, sand escaping, and by correspondingly checking the piston movement using the activation signal 180. A regular check of the functioning of the sand delivery device SFE is additionally or alternatively implemented according to one exemplary embodiment by briefly activating the delivery pressure using the additional activation signal 235 and thus without any, or hardly any, loss of air, and by correspondingly checking the delivery pressure that has built up. Excessive delivery pressure indicates a blockage in the system and too low a delivery pressure indicates a leak in the system. This affords the advantage that the sand metering device SDE and/or sand delivery device SFE can be tested at any time and as often as desired without a significant amount of sand or air escaping and without the driving operation being restricted.

The following is a description of two exemplary applications of the diagnostic apparatus 110 presented here in conjunction with an electric piston HK with at least two reed contacts as a position sensor for the piston H K.

In the first exemplary application, a sanding request with diagnosis using the diagnostic apparatus 110 presented here is described:

The driver or e.g. the anti-skid system requests sanding from the sanding controller 160 via the vehicle controller while driving. The sanding controller 160 activates the sand metering device SDE and the sand delivery device SFE of the sand metering unit SD. The solenoid HM of the sand metering device SDE is activated periodically via a PWM signal and the piston HK is moved accordingly. A permanent magnet is mounted on the piston HK. The reed contacts 220, 225, which are mounted in a suitable position near the permanent magnet of the piston HK, detect these periodic changes in the position of the piston HK. These position signals 200 are recorded and evaluated by the sanding controller 160, in this case the evaluation device 145. The activation signals 180 are compared with the position signals 200. A corresponding deviation of the signals from one another is detected as an error. The correct or incorrect execution of the sanding request is reported to the vehicle controller, which reports this on to the vehicle driver. At the same time, the sand delivery unit SF is supplied with delivery air 240, which is activated by the solenoid valve MV controlled by the sanding controller 160. The delivery pressure sensor FDS reports the applied pressure and thus correct or incorrect functioning back to the sanding controller 160, here the evaluation device 145. The delivery pressure present (feedback signal) is compared with the stored target pressure. A deviation of the signals from one another is detected as an error. The correct or incorrect execution of the sanding request is also reported here to the vehicle controller, which reports this on to the vehicle driver.

In the second exemplary application, an automatic diagnostic request using the diagnostic apparatus 110 presented here is described:

The diagnostic request is automatically and independently triggered at regular intervals by the sanding controller 160, here the evaluation device 145. The process corresponds to that of the sanding request except that the request brought about by the activation signal 180 is chosen to be so short that the piston HK can just complete one full stroke from the closed position to the open position and back, and the delivery pressure brought about by the additional activation signal 235 has the opportunity to build up to the target pressure assuming that functioning is correct. Here too, the correct or incorrect execution of the diagnostic request is reported to the vehicle controller which, in the event of a negative result, i.e. failure of the sand metering device SDE, reports this on to the vehicle driver.

FIG. 3 is a flowchart of a method 300 for carrying out a diagnosis for a sand metering unit for a sanding system for a rail vehicle according to one exemplary embodiment. This method 300 can be controlled and/or carried out by the diagnostic apparatus described in FIG. 1 or 2.

The method 300 comprises a detection step 305 and an output step 310. In detection step 305, a parameter of the sand metering unit is detected and a detection signal representing the parameter is provided. In output step 310, a metering error signal is output using the detection signal if the parameter deviates from a target parameter, wherein the metering error signal indicates a malfunction of the sand metering unit.

If an exemplary embodiment comprises an “and/or” combination between a first feature and a second feature, this is to be read as meaning that the exemplary embodiment, according to one embodiment, has both the first feature and the second feature and, according to a further embodiment, has either only the first feature or only the second feature.

### LIST OF REFERENCE SIGNS

AH Shut-off valve
DG Bogie
FDS Delivery pressure sensor
HBL Main air tank line
HK Piston
HM Solenoid
MV Solenoid valve
RD Wheel
RS-O Sensor detecting HK open position
RS-G Sensor detecting HK closed position
SD Sand metering unit
SDE Sand metering device
SF Sand delivery unit
SFE Sand delivery device
SK Sandbox
SR Sand pipe
100 Rail vehicle
105 Sanding system
110 Diagnostic apparatus
120 Rail
130 Wheel rail gap
135 Direction of travel
140 Detection device
145 Evaluation device
150 Detection signal
155 Metering error signal
160 Sanding controller
165 Vehicle controller
170 Vehicle driver
175 Target parameter signal
180 Activation signal
200 Position signal
205 Activation device
215 Open signal
220 Reed sensor
225 Additional reed sensor
230 Closed signal
233 Delivery pressure signal
235 Additional activation signal
240 Delivery air
245 Sand flow
250 Metering function signal
300 Method for carrying out a diagnosis for a sand metering unit for a sanding system for a rail vehicle
305 Detection step
310 Output step

1. A diagnostic apparatus for a sand metering unit for a sanding system for a rail vehicle, the diagnostic apparatus comprising:
a detection device configured to detect at least one parameter of the sand metering unit of the sanding system and to provide a detection signal representing the at least one parameter, and
an evaluation device configured to output a metering error signal using the detection signal, which metering error signal indicates a malfunction of the sand metering unit if in response to the parameter deviating from a target parameter.

2. The diagnostic apparatus of claim 1,
wherein the detection device is configured to detect a position of a piston of a sand metering device of the sanding system as the parameter and to provide a position signal representing the position as the detection signal, wherein the evaluation device is configured to output a sand metering error signal using the position signal as the metering error signal which indicates a malfunction of the sand metering device in response to the position deviating from a target position.

3. The diagnostic apparatus of claim 2, having an activation device configured to output an activation signal which is configured to bring about a piston movement of the piston to the target position.

4. The diagnostic apparatus of claim 3, wherein the activation device is configured to output the activation signal which is configured to bring about the piston movement of the piston to the target position, which is an opened open position of the piston.

5. The diagnostic apparatus of claim 2, wherein the activation device is designed configured to automatically output the activation signal in response to a manually effected, input actuation and/or in a pulse-width modulation interval.

6. The diagnostic apparatus of claim 2, wherein the detection device configured to detect an open position of the piston as the position and to provide an open signal representing the open position and/or to detect a closed position of the piston and to provide a closed signal representing the closed position and/or to detect at least one center position of the piston between the open position and the closed position and to provide a center signal representing the center position.

7. The diagnostic apparatus of claim 1, wherein the detection device is configured to detect a delivery pressure of a sand delivery device of the sanding system as the parameter and to provide a delivery pressure signal representing the delivery pressure as the detection signal, wherein the evaluation device is configured to output a pressure error signal using the delivery pressure signal as the metering error signal which indicates a malfunction of the sand delivery device in response to the delivery pressure deviating from a target delivery pressure.

8. The diagnostic apparatus of claim 1, wherein the detection device comprises at least one reed sensor, proximity sensor, microswitch, triangulation rangefinder, permanent magnet and/or at least one delivery pressure sensor.

9. The diagnostic apparatus of claim 1, wherein the evaluation device is configured to output a metering function signal using the detection signal, which indicates correct functioning of the sand metering unit in response to the parameter corresponding to the target parameter.

10. The diagnostic apparatus of claim 1, wherein the evaluation device is configured to output the metering error signal which is configured to perceptibly indicate the malfunction of the sand metering unit to a vehicle driver of the rail vehicle.

11. A method for carrying out a diagnosis for a sand metering unit for a sanding system for a rail vehicle, the method comprising:
detecting a parameter of the sand metering unit and providing a detection signal representing the parameter, and
outputting a metering error signal using the detection signal in response to the parameter deviating from a target parameter, wherein the metering error signal indicates a malfunction of the sand metering unit.

12. A non-transitory computer readable medium storing a computer program configured to execute and/or control the method claim 11.

13. (canceled)

14. The method of claim 12, wherein the detection device is configured to detect a position of a piston of a sand metering device of the sanding system as the parameter and to provide a position signal representing the position as the detection signal, wherein the evaluation device is configured to output a sand metering error signal using the position signal as the metering error signal which indicates a malfunction of the sand metering device in response to the position deviating from a target position.

15. The method of claim 14, having an activation device configured to output an activation signal which is configured to bring about a piston movement of the piston to the target position.

16. The method of claim 15, wherein the activation device is configured to output the activation signal which is configured to bring about the piston movement of the piston to the target position, which is an opened open position of the piston.

17. The method of claim 14, wherein the activation device is configured to automatically output the activation signal in response to a manually effected, input actuation and/or in a pulse-width modulation interval.

18. The method of claim 14, wherein the detection device is configured to detect an open position of the piston as the position and to provide an open signal representing the open position and/or to detect a closed position of the piston and to provide a closed signal representing the closed position and/or to detect at least one center position of the piston between the open position and the closed position and to provide a center signal representing the center position.

19. The method of claim 12, wherein the detection device is configured to detect a delivery pressure of a sand delivery device of the sanding system as the parameter and to provide a delivery pressure signal representing the delivery pressure as the detection signal, wherein the evaluation device is configured to output a pressure error signal using the delivery pressure signal as the metering error signal which indicates a malfunction of the sand delivery device in response to the delivery pressure deviating from a target delivery pressure.

20. The method of claim 12, wherein the detection device comprises at least one reed sensor, proximity sensor, microswitch, triangulation rangefinder, permanent magnet and/or at least one delivery pressure sensor.

21. The method of claim 12, wherein the evaluation device is configured to output a metering function signal using the detection signal, which indicates correct functioning of the sand metering unit in response to the parameter corresponding to the target parameter.

22. The method of claim 12, wherein the evaluation device is configured to output the metering error signal which is configured to perceptibly indicate the malfunction of the sand metering unit to a vehicle driver of the rail vehicle.
